(19) United States
(12) Patent Application Publication
(10) Pub. No.: US 2019/0187964 A1
(43) Pub. Date: Jun. 20, 2019

(54) Method and Apparatus for Compiler Driven Bank Conflict Avoidance

(71) Applicant: Advanced Micro Devices, Inc., Sunnyvale, CA (US)

(72) Inventors: Mark U. Wyse, Seattle, WA (US); Bradford Michael Beckmann, Redmond, WA (US); John Kalamatianos, Arlington, MA (US); Anthony Thomas Gutierrez, Seattle, WA (US)

(21) Appl. No.: 15/848,476

(22) Filed: Dec. 20, 2017

(51) Int. Cl. G06F 8/41

(52) U.S. Cl. CPC G06F 8/4434; G06F 8/433

(57) ABSTRACT

Systems, apparatuses, and methods for converting computer program source code from a first high level language to a functionally equivalent executable program code. Source code in a first high level language is analyzed by a code compilation tool. In response to identifying a potential bank conflict in a multi-bank register file, operands of one or more instructions are remapped such that they map to different physical banks of the multi-bank register file. Identifying a potential bank conflict comprises one or more of identifying an intra-instruction bank conflict, an inter-instruction bank conflict, and identifying a multi-word operand with a potential bank conflict.

### BACKGROUND

Most businesses today rely heavily on computer programs to efficiently and effectively run and manage their operations. For example, businesses rely on computer programs to manage inventory, distribution, accounting, employee management, and so on. Likewise, individuals rely on computer programs to manage and enhance their daily lives. For example, individuals may use various programs on desktop or mobile devices to create documents, manage their personal finances, and track their kid's school activities. As such, computer programs are an indispensable part of our everyday lives.

During execution of a computer program by a processor, activities including computations and manipulations of data are performed frequently. In order to store and maintain the computer programs and data, the processor includes a memory system generally organized in a hierarchical manner. The latency associated with accessing data in the memory system will generally depend on its location within the hierarchy. For example, data stored on a mass storage device may be considered one extreme of the hierarchy and may have the longest access latency. Conversely, data stored in processor registers may be considered the other extreme of the memory hierarchy and may have the shortest access latency.

While data stored in processor registers may have a relatively short access latency, there may be circumstances which cause an access to a register to have an increased latency. For example, in a system that includes registers in a banked register file, a bank access conflict occurs when instructions need to access unique registers from the same register file bank in the same cycle. Bank access conflicts may occur when either reading or writing registers. Such conflicts force some of the access requests to be delayed, or stalled, and reattempted at a later time. Consequently, if an instruction is waiting to execute but it is unable to read an operand from the register file due to a bank conflict, that instruction must stall for at least one cycle until the read operation can be reattempted. These stalls decrease the instruction issue rate and are detrimental to the performance of the processor.

In view of the above, methods and mechanisms for reducing the number of register file bank access conflicts are desired.

### BRIEF DESCRIPTION OF THE DRAWINGS

FIG. 1 illustrates one embodiment of a system for compiling source code from an original high level language to executable code.

FIG. 2 illustrates one embodiment of a multi-bank register file.

FIG. 3 illustrates one embodiment of program code analysis and conversion method.

FIG. 4 illustrates one embodiment of a method for identifying a remapping potential bank conflicts.

FIG. 5 is a block diagram illustrating a computing device configured to analyze and compile source code according to at least some embodiments.

While the invention is described herein by way of example for several embodiments and illustrative drawings, those skilled in the art will recognize that the invention is not limited to the embodiments or drawings described. It should be understood that the drawings and detailed description hereto are not intended to limit the invention to the particular form disclosed, but on the contrary, the invention is to cover all modifications, equivalents and alternatives falling within the spirit and scope of the present invention as defined by the appended claims. Any headings used herein are for organizational purposes only and are not meant to limit the scope of the description or the claims. As used herein, the word “may” is used in a permissive sense (i.e., meaning having the potential to) rather than the mandatory sense (i.e. meaning must). Similarly, the words “include”, “including”, and “includes” mean including, but not limited to.

### DETAILED DESCRIPTION OF EMBODIMENTS

The invention described herein was made with government support under PathForward Project with Lawrence Livermore National Security Prime Contract No. DE-AC52-07NA27344, Subcontract No. B620717 awarded by the United States Department of Energy. The United States Government has certain rights in the invention.

In the following description, numerous specific details are set forth to provide a thorough understanding of the methods and mechanisms presented herein. However, one having ordinary skill in the art should recognize that the various embodiments can be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

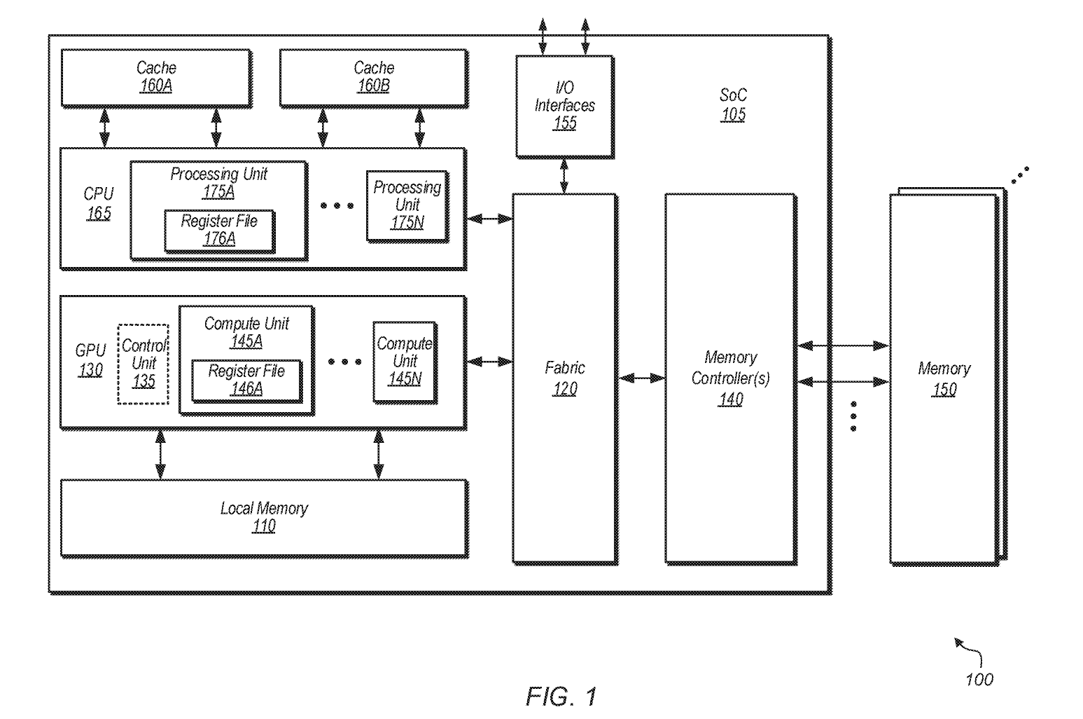

Referring now to FIG. 1, a block diagram of one embodiment of a computing system 100 is shown. In one embodiment, computing system 100 includes system on chip (SoC) 105 coupled to memory 150. SoC 105 can also be referred to as an integrated circuit (IC). In one embodiment, SoC 105 includes processing units 175A-N of central processing unit (CPU) 165, input/output (I/O) interfaces 155, caches 160A-B, fabric 120, graphics processing unit (GPU) 130, local memory 110, and memory controller(s) 140. SoC 105 can also include other components not shown in FIG. 1 to avoid obscuring the figure. Processing units 175A-N are representative of any number and type of processing units. In one embodiment, processing units 175A-N are CPU cores. In another embodiment, one or more of processing units 175A-N are other types of processing units (e.g., application specific integrated circuit (ASIC), field programmable gate array (FPGA), digital signal processor (DSP)). Processing units 175A-N of CPU 165 are coupled to caches 160A-B and fabric 120.

In one embodiment, processing units 175A-N are configured to execute instructions of a particular instruction set architecture (ISA). Each processing unit 175A-N includes one or more execution units, cache memories, schedulers, branch prediction circuits, and so forth. In one embodiment, the processing units 175A-N are configured to execute the main control software of system 100, such as an operating system. Generally, software executed by processing units 175A-N during use can control the other components of system 100 to realize the desired functionality of system 100. Processing units 175A-N can also execute other software, such as application programs.

GPU 130 includes at least control unit 135 and compute units 145A-N. It is noted that control unit 135 can also be located in other locations (e.g., fabric 120, memory controller 140). Control unit 135 includes logic for generating target memory addresses for received write requests which do not include specified target memory addresses. Compute units 145A-N are representative of any number and type of compute units that are used for graphics or general-purpose processing. Each compute unit 145A-N includes any number of execution units, with the number of execution units per compute unit varying from embodiment to embodiment. GPU 130 is coupled to local memory 110 and fabric 120. In one embodiment, local memory 110 is implemented using high-bandwidth memory (HBM). The combination of local memory 110 and memory 150 can be referred to herein as a “memory subsystem”. Alternatively, either local memory 110 or memory 150 can be referred to herein as a “memory subsystem”.

In one embodiment, GPU 130 is configured to execute graphics pipeline operations such as draw commands, pixel operations, geometric computations, rasterization operations, and other operations for rendering an image to a display. In another embodiment, GPU 130 is configured to execute operations unrelated to graphics. In a further embodiment, GPU 130 is configured to execute both graphics operations and non-graphics related operations.

In one embodiment, GPU 130 is configured to launch a plurality of threads on the plurality of compute units 145A-N, wherein each thread generates memory requests without specifying target memory addresses. The plurality of compute units 145A-N convey a plurality of memory requests to control unit 135. Control unit 135 generates target memory addresses for the plurality of received memory requests.

I/O interfaces 155 are coupled to fabric 120, and I/O interfaces 155 are representative of any number and type of interfaces (e.g., peripheral component interconnect (PCI) bus, PCI-Extended (PCI-X), PCIE (PCI Express) bus, gigabit Ethernet (GBE) bus, universal serial bus (USB)). Various types of peripheral devices can be coupled to I/O interfaces 155. Such peripheral devices include (but are not limited to) displays, keyboards, mice, printers, scanners, joysticks or other types of game controllers, media recording devices, external storage devices, network interface cards, and so forth.

SoC 105 is coupled to memory 150, which includes one or more memory modules. Each of the memory modules includes one or more memory devices mounted thereon. In some embodiments, memory 150 includes one or more memory devices mounted on a motherboard or other carrier upon which SoC 105 is also mounted. In one embodiment, memory 150 is used to implement a random access memory (RAM) for use with SoC 105 during operation. The RAM implemented can be static RAM (SRAM), dynamic RAM (DRAM), Resistive RAM (ReRAM), Phase Change RAM (PCRAM), or any other volatile or non-volatile RAM. The type of DRAM that is used to implement memory 150 includes (but is not limited to) double data rate (DDR) DRAM, DDR2 DRAM, DDR3 DRAM, and so forth. Although not explicitly shown in FIG. 1, SoC 105 can also include one or more cache memories that are internal to the processing units 175A-N and/or compute units 145A-N. In some embodiments, SoC 105 includes caches 160A-B that are utilized by processing units 175A-N. In one embodiment, caches 160A-B are part of a cache subsystem including a cache controller.

It is noted that the letter “N” when displayed herein next to various structures is meant to generically indicate any number of elements for that structure (e.g., any number of processing units 175A-N in CPU 165, including one processing unit). Additionally, different references within FIG. 1 that use the letter “N” (e.g., compute units 145A-N) are not intended to indicate that equal numbers of the different elements are provided (e.g., the number of processing units 175A-N in CPU 165 can differ from the number of compute units 145A-N of GPU 130).

As shown in FIG. 1, processing unit 175A includes a register file 176A and compute unit 145A includes a register file 146A. For purposes of discussion, the register file 146A in GPU 130 will be discussed. However, it is noted that the methods and mechanisms described herein can be applied to the register file 176A in the CPU 165 as well.

In various embodiments, computing system 100 can be a computer, laptop, mobile device, server or any of various other types of computing systems or devices. It is noted that the number of components of computing system 100 and/or SoC 105 can vary from embodiment to embodiment. There can be more or fewer of each component/subcomponent than the number shown in FIG. 1. For example, in another embodiment, SoC 105 can include multiple memory controllers coupled to multiple memories. It is also noted that computing system 100 and/or SoC 105 can include other components not shown in FIG. 1. Additionally, in other embodiments, computing system 100 and SoC 105 can be structured in other ways than shown in FIG. 1.

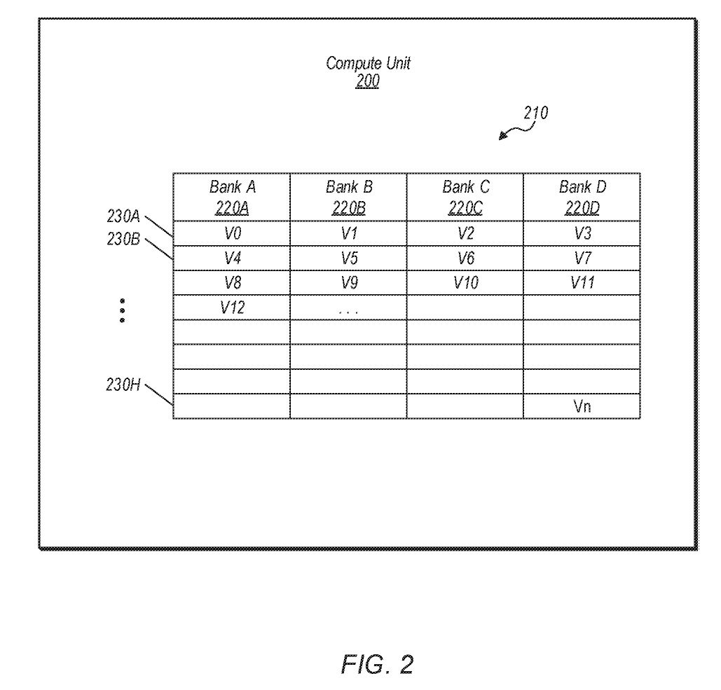

As discussed above, a register file can be a memory structure with multiple banks. In such an embodiment, a given bank can only support a single access (read or write) at any given time. Consequently, if there are two (or more) pending accesses to a given bank of the register file 146A, one of the accesses will have to wait until the other has been performed before it can access the register file. As an example, FIG. 2 illustrates one embodiment of a multi-bank register file 210. In this example, the register file includes four separate banks—bank A 220A, bank B 220B, bank C 220C, and bank D 220D. Bank A 220A is shown to include multiple entries. The first entry, 230A, represents a register V0, a second entry, 230B, represents a register V4, and so on to a last entry 230H within that bank. In other embodiments, the register file 210 has a different number of banks and/or a different number of entries for each bank.

As noted above, under some circumstances, instructions attempt to access registers that reside in the same physical banks in the same cycle, resulting in a bank access conflict. For example, assuming the register file organization depicted in FIG. 2, the following instruction V0=V1+V9 includes two operands in the same physical bank. In this case, both of the register V1 and V9 reside in bank B 220B. Consequently, accesses to the registers V1 and V9 must be serialized. This serialization of accesses increases the execution latency of the instruction. If on the other hand, the registers V1 and V9 were located in different physical banks, an access to both registers could be performed simultaneously and the execution latency of the instruction could be reduced.

In many processor architectures, register renaming is used by the processor at runtime to assign physical registers for use in storing instruction operands, results, and so on. Neither the application programmer nor compiler generally has insight into what register renaming is occurring during execution of a program. Typically, the programmer utilizes meaningful names (e.g., in a high level programming language) to represent variables and other entities within a computer program. A compiler then translates the programmer's program code into a machine language executable by a given processor architecture. To accomplish this, the compiler typically has knowledge of the programmer visible registers (alternately referred to as “virtual registers”) of a given processor architecture and transforms the programmer's program code into program instructions that use these programmer visible registers. The identification and use of these programmer visible registers within the translated code serve to maintain the semantic correctness of the program code as intended by the programmer.

At runtime the processor has a (typically larger) set of physical registers at its disposal for use in executing programs. In order to improve the efficiency of program execution, the processor will rename (or “map”) the programmer visible registers in the program code to one of these physical registers. This is referred to as “register renaming”. While this can improve the efficiency of the execution of the program code, in some cases the processor will assign operands of a given instruction to the same physical bank of a banked register file. Consequently, the above discussed problem of bank conflicts can occur which introduce undesired latency into the execution of the program code.

In order to address the above, embodiments of a program code compiler are contemplated that consider the physical bank placement of registers in order to reduce bank conflicts. In various embodiments, the compiler has knowledge of the virtual to physical register mappings and physical register bank placement in a given processor architecture and uses this knowledge when compiling program code avoid bank conflicts.

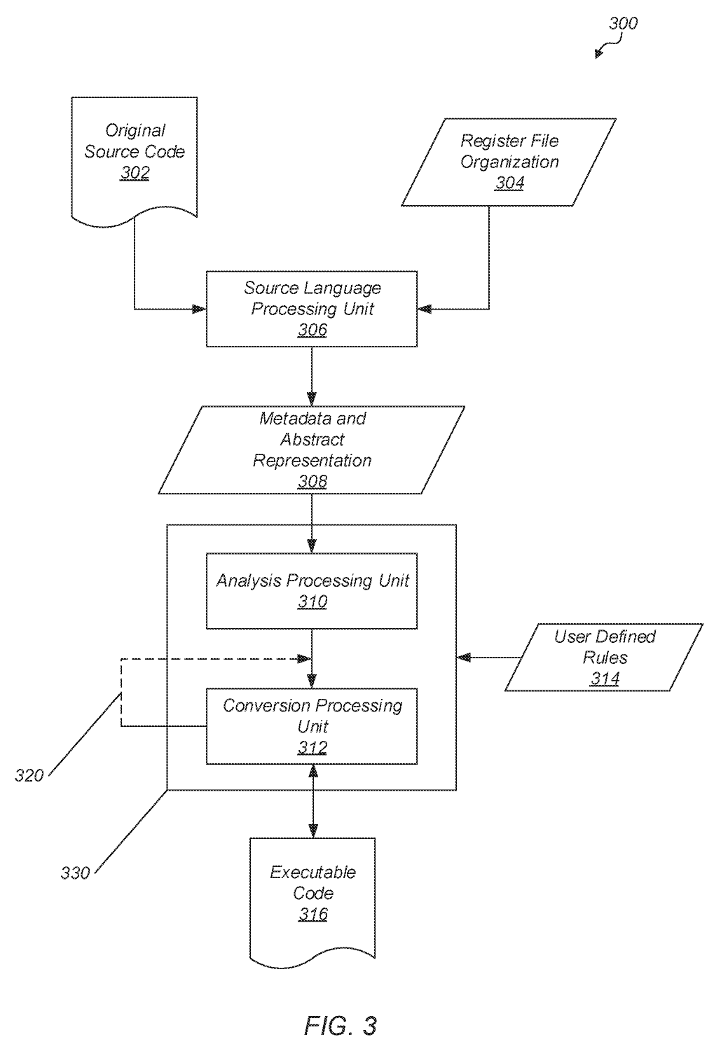

FIG. 3 illustrates a high level view of a method for performing compilation of program code. As used herein, a high level language refers to a programming language that is expressed in human-readable code that applies a common language specification for understanding human-readable words to express desired software functionality. Examples of high level languages include the programming languages C, C++, Open Graphics Library (OpenGL), Java®, Python, JavaScript, PHP, as well as many others. In the illustrated embodiment, various sources of data and units configured to process data are depicted and are discussed below.

As shown in FIG. 3, a source language processing unit (or compilation tool) 306 is illustrated. In various embodiments, this source language processing unit 306 may comprise or otherwise correspond to one or more units typically associated with a compiler frontend. To this end, the source language processing unit 306 includes functionality to analyze original source code 302 and produce metadata and/or one or more abstract representations of the original source code. Such metadata and abstract representation can include a symbol table, an abstract syntax tree, and other entities known to those skilled in the art. Generally speaking, the source language processing unit 306 is configured to process source code corresponding to a particular high level language—such as the C programming language, the C++ programming language, or otherwise.

In the example shown, information 304 regarding the register file organization of a given processor architecture can be used to configure the source language processing unit 306 in various ways. For example, register file organization 304 can indicate which programmer visible registers (virtual registers) correspond to the same physical bank of a register. For example, the information 304 can indicate the registers V0, V4, and V8 correspond to one physical bank of the register file, while registers V1, V5, and so on, correspond to a different physical bank of the register file. In some embodiments, the target processor (i.e., the processor architecture for which the program code is being compiled) can still perform register renaming. However, the organization of the register file as indicated by the information 304 will be consistent with the physical banks to which the processor renames registers. For example, if information 304 indicates V0, V4, and V8 correspond to a same physical bank of a register file, then any renaming performed by the processor will ensure that V0, V4, and V8 are consistently renamed to physical registers of the same physical bank.

In addition to the above register file organization, the information 304 can also include other information for use by the compilation tool and can generally be considered configuration information. For example, the information 304 can also indicate the physical register file size, the number of read and write ports per bank of the register file, a particular type of source code to be processed, potential optimizations to the code during compilation, and so on. A variety of such options are possible and are contemplated.

Also illustrated in FIG. 3 are an analysis processing unit (or tool) 310 and a conversion processing unit (or tool) 312. In various embodiments, each of the units illustrated in FIG. 3 represent executable program code. Though it is to be understood that in other embodiments, units or even portions of such units can represent hardware (e.g., circuitry designed to perform the functionality of the corresponding unit). For ease of discussion, each of units 306, 310, and 312, are depicted as separate and distinct units. As such they can represent, and be implemented, as completely separate units. For purposes of discussion, the units 310 and 312 can be collectively referred to as a code conversion tool despite the fact they can be implemented as separate and distinct tools. In one embodiment, source language processing unit 306 represents one application (or tool) and analysis and conversion units 310 and 312, respectively, together form a second application (or tool) 330. Alternatively, all units can be included as part of a single tool or application.

As shown in the example, source language processing unit 306 takes as input original source code 302 and generates metadata and abstract representation 308. In various embodiments, the metadata and/or abstract representation includes an identification of each symbol used in the source code. In addition, symbols or statements with a particular meaning are identified. Symbols, statements, and collections of statements or symbols with such semantic content are identified and can generally be referred to herein as “semantic entities.” Examples of semantic entities include, but are not limited to, constructors, fields, local variables, methods and functions, packages, parameters, types, and so on. Additionally, in some embodiments, a fully qualified name (FQN) can be generated for each symbol. As those skilled in the art understand, an FQN can be used in order to disambiguate otherwise identical symbols within a given namespace. This generated metadata and abstract representation is then analyzed by analysis processing unit 310. In one embodiment, analysis and processing unit 310 and conversion processing unit 312 are designed to analyze the data 308 with the goal of producing functionally equivalent program code 316 executable by a given processor architecture. In some embodiments, the code 316 can represent code directly executable by a processor. In other embodiments, code 316 can represent an intermediate form (e.g., bytecode or otherwise) that is executable at runtime by a virtual machine to produce instructions executable by a processor. For purposes of discussion, code 316 generated will be assumed to be instructions that are directly executable by a (hardware) processor.

In one embodiment, the processing performed by the analysis processing unit 310 and the conversion processing unit 312 can be at least in part iterative. For example, as will be described in greater detail, analysis processing unit 310 can analyze the data generated by the source language processing unit 306. Based upon this analysis, the analysis processing unit 330 creates data that identifies structures and elements in the original source code 302 that require corresponding code in the new source code 316. Based upon this data, the conversion processing unit 312 generates executable code 316. Similar to the configuration data 304, user defined rules 314 or other configuration data can be used to control the analysis processing unit 310 and/or conversion processing unit 312. Once it is determined that processing by the analysis 310 and conversion processing unit 312 are complete, the workflow of FIG. 3 is complete.

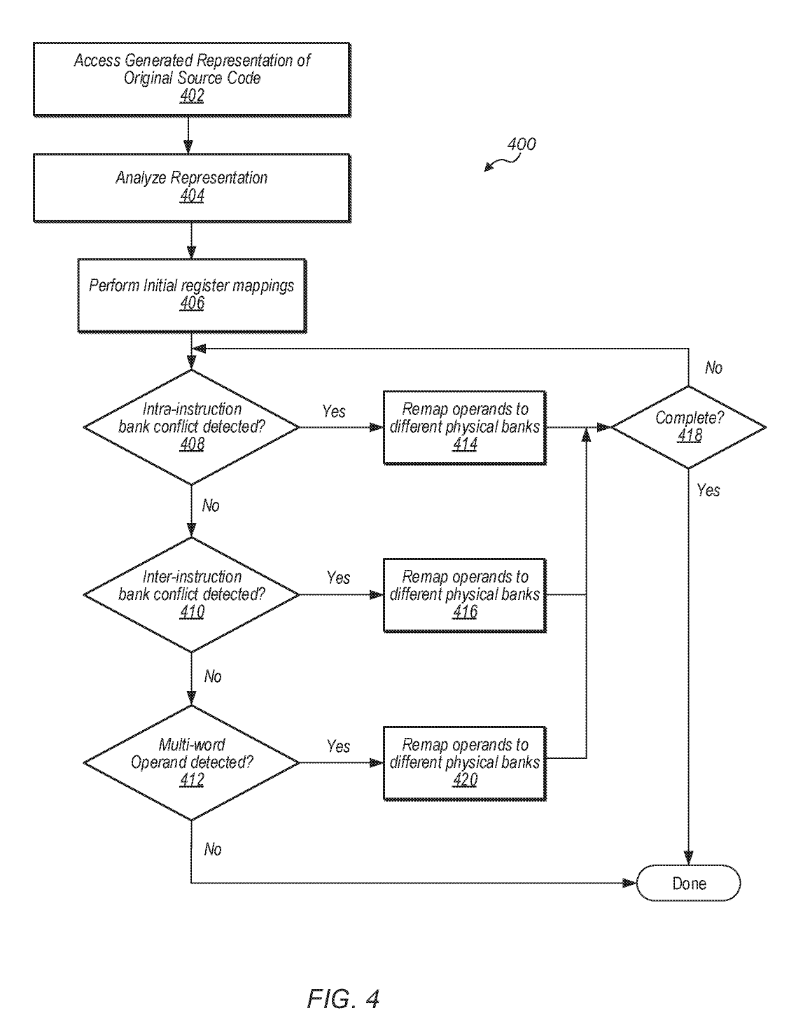

Turning now to FIG. 4, one embodiment of a method 400 for performing compilation of program code in a manner that seeks to avoid bank conflicts is illustrated. In various embodiments, after having processed original source code to generated representations of the program code and other data (e.g., the abstract representation and metadata 308 of FIG. 3), the analysis processing unit 310 identifies particular portions of program code that can give rise to bank conflicts. In some embodiments, the compilation tool can perform an initial mapping of registers to instructions in the program code and then review the initial mapping for possible bank conflicts. In other embodiments, a more full analysis for potential bank conflicts can be performed before a mapping of registers is performed. Various such embodiments are possible and are contemplated.

In this example, it is assumed that an initial mapping of virtual registers for program instructions is performed by the compilation tool. It is noted that while the steps are presented in a given order in FIG. 4, the steps can be performed in a different order and various steps can be performed concurrently. After having generated a representation of the program code (block 402), the representation is accessed, analyzed (block 404), and an initial mapping of virtual registers to program instructions performed (block 406). Having performed the mapping, the analysis can continue by analyzing the mappings to determine if any intra-instruction bank conflicts exist (block 408). An intra-instruction bank conflict will be deemed to exist by the compilation tool if a given instruction has source and/or destination operands that map to a same physical bank. In other words, the virtual registers assigned for the source and/or destination operands map to a same physical bank. If such an intra-instruction bank conflict is detected, the compilation tool will remap the operands of the instruction so that the source and/or destination operands map to different physical banks of the register file (block 414). If the processing of the program code is not complete (block 418), the analysis will continue.

If no (further) intra-instruction bank conflicts are detected (block 408), then mappings are analyzed to determine if any inter-instruction bank conflicts are present (block 410). For example, multi-instruction blocks of program code can be analyzed to identify instructions in close proximity to one another that have source and/or destination operands that map to a given physical bank. Instructions that are in close proximity to one another in terms of execution sequence are more likely to have dependencies that give rise to a bank conflict. In some embodiments, the multi-instruction blocks can be basic blocks defined by entry and exit points to a block of code based on control flow analysis of the code. In some embodiments, the compilation tool seeks to identify instructions within a given number of instructions (i.e., a given distance) of the multi-instruction block with virtual registers mapping to the same physical bank.

For example, one instruction that immediately follows another can be deemed to a have a distance of one. One instruction separate from another instruction by exactly one instruction can be deemed to have a distance of two, and so on. In some embodiments, the distance between the two instructions under consideration can be programmable. In some embodiments, the compilation tool can use a varying analysis to determine the distance. For example, the compilation tool can first seek to identify immediately adjacent instructions (instructions with a distance of one) with operands mapping to the same physical bank of the register file. Having completed this analysis, the compilation tool could analyze instructions with a distance of two for operands that map to the same physical bank, then a distance of three, and so on. Analyzing the instructions at increasing distances can be considered increasing aggressiveness in terms of optimization and can itself be programmable. Once an (potential) inter-instruction bank conflict is detected, the compilation tool can remap/reassign the virtual registers of the instruction (block 416) in question to avoid mapping to the same physical bank. If the processing of the program code is not complete (block 418), the analysis will continue.

If no (further) inter-instruction bank conflicts are detected (block 410), then mappings are analyzed to determine if any instructions utilize multi-word operands (block 412). Similar to an intra-instruction bank conflict, it is undesirable to have to wait for accesses to operands of the instruction. In the case of multi-word operands, the operand can span more than one register. Consequently, it is possible for portions of a single operand to reside in different entries of a given physical bank (e.g., where each register can only store a single word). As such, accesses for the different portions of the single operands will have to be serialized and the access latency for the instruction will be increased. To avoid such a scenario, the compilation tool identifies such multi-word operands and maps the portions of the operand to different physical banks (block 420). In this manner, multiple portions of the operand can be accessed simultaneously.

Various embodiments are contemplated for assigning virtual registers such that they map to different physical banks. In one embodiment, virtual registers can be mapped to locations in the register file using a base offset into the register file (e.g., an offset that corresponds to a given row of the register file shown in FIG. 2) and an index that identifies a particular bank. For example, in an embodiment in which the register file has N=4 banks, and 256 rows, an offset can identify a particular row and the index can map to one of the banks. In the example illustrated in FIG. 2, the bank can be determined from the index by using a modulo operation. For example, FIG. 2 shows register V10 maps to the third row and bank C 220C of the register file. If we assume that bank A is bank 0, bank B is bank 1, bank C is bank 2 and bank D is bank 3, then in this case the bank can be determined by the index 10 modulo N (i.e., 10 modulo 4) which equals 2. The bank for register V5 would be determined as 5 modulo 4 which equals 1, and so on. Using such an approach, the compilation tool can readily determine whether particular virtual registers map to a given bank and should (perhaps) be remapped to a different register and bank.

It is also noted that the compilation tool analysis can utilize various techniques such as register liveness analysis (i.e., determining the live range of the register values) to determine whether a bank conflict is likely. While there can initially appear to be a bank conflict between two instructions, register liveness analysis can reveal that such is not the case and a remapping can not be necessary. In some embodiments, graph-coloring techniques can be used to during the analysis process to more efficiently identify potential conflicting instructions. For example, when graph coloring is used in register allocation, a graph node represents the live range of a value (from the definition to its last use) and an edge between two nodes indicates an overlap between the value lifetimes. The goal of the register mapping is to color the nodes with as few colors as possible (and no more than what the target processor architecture supports). Bank conflict avoidance logic can be added to the register mapper by marking each graph node with the bank assigned to the selected register, and adding an edge to connect any two nodes assigned to the same bank. The goal of the bank conflict avoidance logic is to minimize the number of edges in the graph (which in turn is equivalent to minimizing the number of potential bank conflicts) by changing the register assignment to nodes. Note that the actual register bank assigned to each register is not known at compile time. However, this is not necessary because the compiler still knows the mapping function (e.g., index modulo N) and can identify which registers will be mapped to the same bank. A variation of the algorithm described above can consider subgraph partitions to avoid bank conflicts in certain regions of code, one example being basic blocks. Other possible regions include sets of straight line code and phases of execution.

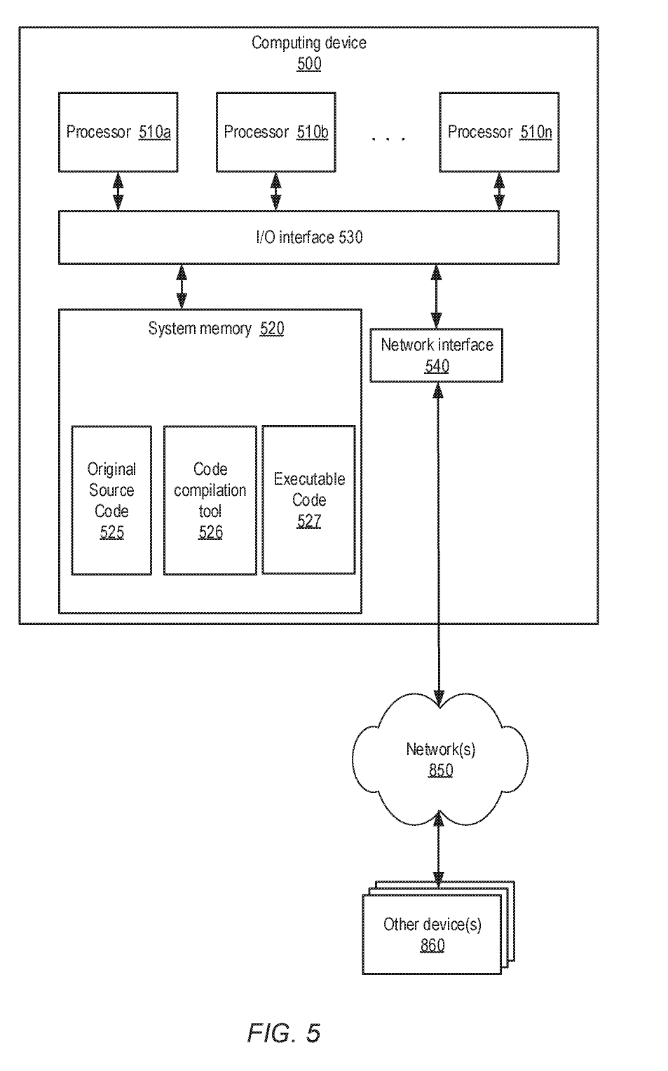

FIG. 5 is a block diagram illustrating a computing device 500 configured to compile program code as described above, according to at least some embodiments. The computer device 500 can correspond to any of various kinds of devices, including, but not limited to, a personal computer system, desktop computer, laptop or notebook computer, mainframe computer system, handheld computer, workstation, network computer, a consumer device, application server, storage device, a peripheral device such as a switch, modem, router, etc., or in general any kind of computing device. In the illustrated embodiment, computing device 500 includes one or more cores or processors 510a-510n coupled to a system memory 520 via an input/output (I/O) interface 530. Computing device 500 further includes a network interface 540 coupled to I/O interface 530.

In various embodiments, computing device 500 can be a uniprocessor system including one processor 510, or a multiprocessor system including several cores or processors 510 (e.g., two, four, eight, or another suitable number). Processors 510 can be any suitable processors capable of executing instructions. For example, in various embodiments, processors 510 can be general-purpose or embedded processors implementing any of a variety of instruction set architectures (ISAs), such as an x86 architecture, the SPARC, PowerPC, or MIPS ISAs, or any other suitable ISA. In multiprocessor systems, each of processors 510 can commonly, but not necessarily, implement the same ISA.

System memory 520 can be configured to store program instructions implementing a program code compilation tool 526, original source code 525, and new executable code 527 generated by the code compilation tool 526. System memory can also include program instructions and/or data for various other applications. In various embodiments, system memory 520 can be implemented using any suitable memory technology, such as static random access memory (SRAM), synchronous dynamic RAM (SDRAM), nonvolatile/Flash-type memory, or any other kind of memory.

In one embodiment, I/O interface 530 can be configured to coordinate I/O traffic between processor 510, system memory 520, and any peripheral devices in the device, including network interface 540 or other peripheral interfaces. In some embodiments, I/O interface 530 can perform any necessary protocol, timing or other data transformations to convert data signals from one component (e.g., system memory 520) into a format suitable for use by another component (e.g., processor 510). In some embodiments, I/O interface 530 can include support for devices attached through various types of peripheral buses, such as a variant of the Peripheral Component Interconnect (PCI) bus standard or the Universal Serial Bus (USB) standard, for example. In some embodiments, the function of I/O interface 530 can be split into two or more separate components, such as a north bridge and a south bridge, for example. Also, in some embodiments some or all of the functionality of I/O interface 530, such as an interface to system memory 520, can be incorporated directly into processor 510.

Network interface 540 can be configured to allow data to be exchanged between computing device 500 and other devices 560 attached to a network or networks 550, for example. In various embodiments, network interface 540 can support communication via any suitable wired or wireless general data networks, such as types of Ethernet network, for example. Additionally, network interface 540 can support communication via telecommunications/telephony networks such as analog voice networks or digital fiber communications networks, via storage area networks such as Fibre Channel SANs, or via any other suitable type of network and/or protocol.

In some embodiments, system memory 520 can be one embodiment of a computer-accessible medium configured to store program instructions and data as described above for FIG. 1 through 4 for implementing embodiments of the corresponding methods and apparatus. However, in other embodiments, program instructions and/or data can be received, sent or stored upon different types of computer-accessible media. Generally speaking, a computer-accessible medium can include non-transitory storage media or memory media such as magnetic or optical media, e.g., disk or DVD/CD coupled to computing device 500 via I/O interface 530. A non-transitory computer-accessible storage medium can also include any volatile or non-volatile media such as RAM (e.g. SDRAM, DDR SDRAM, RDRAM, SRAM, etc.), ROM, etc., that can be included in some embodiments of computing device 500 as system memory 520 or another type of memory. Further, a computer-accessible medium can include transmission media or signals such as electrical, electromagnetic, or digital signals, conveyed via a communication medium such as a network and/or a wireless link, which can be implemented via network interface 540. Portions or all of multiple computing devices such as that illustrated in FIG. 5 can be used to implement the described functionality in various embodiments; for example, software components running on a variety of different devices and servers can collaborate to provide the functionality. In some embodiments, portions of the described functionality can be implemented using storage devices, network devices, or special-purpose computer systems, in addition to or instead of being implemented using general-purpose computer systems. The term “computing device”, as used herein, refers to at least all these types of devices, and is not limited to these types of devices.

Various embodiments can further include receiving, sending or storing instructions and/or data implemented in accordance with the foregoing description upon a computer-accessible medium. Generally speaking, a computer-accessible medium can include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent exemplary embodiments of methods. The methods can be implemented in software, hardware, or a combination thereof. The order of method can be changed, and various elements can be added, reordered, combined, omitted, modified, etc.

Various modifications and changes can be made as would be obvious to a person skilled in the art having the benefit of this disclosure. It is intended to embrace all such modifications and changes and, accordingly, the above description to be regarded in an illustrative rather than a restrictive sense.

1. A non-transitory, computer-readable storage medium storing program instructions that when executed on a computing device cause the computing device to perform:
receiving, by a code compilation tool, a command to compile source code from a first high level language to executable program code;
accessing, by the code compilation tool, the source code in the first high level language;
analyzing, by the code compilation tool, the source code in the first high level language;
responsive to identifying a potential bank conflict in a multi-bank register file, the code compilation tool remapping one or more virtual registers of operands of one or more instructions such that the remapped virtual registers of the one or more operands correspond to different physical banks of the multi-bank register file; and
outputting the executable program code with the virtual registers of the one or more operands as remapped.

2. The non-transitory computer-readable storage medium as recited in claim 1, wherein identifying a potential bank conflict comprises identifying a physical bank of the multi-bank register file to which an operand of the one or more operands is mapped.

3. The non-transitory computer-readable storage medium as recited in claim 2, wherein identifying a potential bank conflict comprises detecting an intra-instruction bank conflict, wherein the intra-instruction bank conflict comprises a single instruction with at least two operands that map to a single physical bank of the multi-bank register file.

4. The non-transitory computer-readable storage medium as recited in claim 2, wherein identifying a potential bank conflict comprises detecting an instruction with a multi-word operand, wherein the multi-word operand comprises a single operand with at least two portions mapped to two different registers in the multi-bank register file and the two different registers are in a same physical bank of the multi-bank register file.

5. The non-transitory computer-readable storage medium as recited in claim 2, wherein identifying a potential bank conflict comprises detecting an inter-instruction bank conflict, wherein the inter-instruction bank conflict comprises a first instruction with at least one operand that maps to a same physical bank of the multi-bank register file as an operand of a second instruction different than the first instruction.

6. The non-transitory computer-readable storage medium as recited in claim 5, wherein detecting the inter-instruction bank conflict comprises analyzing multiple instructions within a multi-instruction block.

7. The non-transitory computer-readable storage medium as recited in claim 1, wherein identifying a potential bank conflict in the multi-bank register file comprises:
generating a graph corresponding to the source code;
using graph-coloring to identify nodes representing a live range of a value stored in a given register in the source code;
storing an indication associated with each node that indicates a given bank assigned to the given register;
adding an edge to connect any two nodes assigned to the given bank; and
re-allocating registers to reduce a number of edges in the graph.

8. A computer implemented method for compiling program source code from a first high level language to executable code, wherein said method comprises:
a computing device comprising circuitry:
receiving a command to compile source code from a first high level language to executable program code;
accessing the source code in the first high level language;
analyzing the source code in the first high level language;
responsive to identifying a potential bank conflict in a multi-bank register file, remapping one or more virtual registers of operands of one or more instructions such that the remapped virtual registers of the one or more operands correspond to different physical banks of the multi-bank register file; and
outputting the executable program code with the virtual registers of the one or more operands as remapped.

9. The computer implemented method as recited in claim 8, wherein identifying a potential bank conflict comprises identifying a physical bank of the multi-bank register file to which an operand of the one or more operands is mapped.

10. The computer implemented method as recited in claim 9, wherein identifying a potential bank conflict comprises detecting an intra-instruction bank conflict, wherein the intra-instruction bank conflict comprises a single instruction with at least two operands that map to a single physical bank of the multi-bank register file.

11. The computer implemented method as recited in claim 9, wherein identifying a potential bank conflict comprises detecting an instruction with a multi-word operand, wherein the multi-word operand comprises a single operand with at least two portions mapped to two different registers in the multi-bank register file and the two different registers are in a same physical bank of the multi-bank register file.

12. The computer implemented method as recited in claim 9, wherein identifying a potential bank conflict comprises detecting an inter-instruction bank conflict, wherein the inter-instruction bank conflict comprises a first instruction with at least one operand that maps to a same physical bank of the multi-bank register file as an operand of a second instruction different than the first instruction.

13. The computer implemented method as recited in claim 12, wherein detecting the inter-instruction bank conflict comprises analyzing multiple instructions within a multi-instruction block.

14. The computer implemented method as recited in claim 13, wherein detecting the inter-instruction bank conflict further comprises analyzing instructions within the multi-instruction block that are within a programmable distance of one another.

15. A computing device comprising circuitry configured to:
receive a command to compile source code from a first high level language to executable program code;
access the source code in the first high level language;
analyze the source code in the first high level language;
responsive to identifying a potential bank conflict in a multi-bank register file, remap one or more virtual registers of operands of one or more instructions such that the remapped virtual registers of the one or more operands correspond to different physical banks of the multi-bank register file; and
output the executable program code with the virtual registers of the one or more operands as remapped.

16. The computing device as recited in claim 15, wherein identifying a potential bank conflict comprises identifying a physical bank of the multi-bank register file to which an operand of the one or more operands is mapped.

17. The computing device as recited in claim 16, wherein identifying a potential bank conflict comprises detecting an intra-instruction bank conflict, wherein the intra-instruction bank conflict comprises a single instruction with at least two operands that map to a single physical bank of the multi-bank register file.

18. The computing device as recited in claim 16, wherein identifying a potential bank conflict comprises detecting an instruction with a multi-word operand, wherein the multi-word operand comprises a single operand with at least two portions mapped to two different registers in the multi-bank register file and the two different registers are in a same physical bank of the multi-bank register file.

19. The computing device as recited in claim 16, wherein identifying a potential bank conflict comprises detecting an inter-instruction bank conflict, wherein the inter-instruction bank conflict comprises a first instruction with at least one operand that maps to a same physical bank of the multi-bank register file as an operand of a second instruction different than the first instruction.

20. The computing device as recited in claim 19, wherein detecting the inter-instruction bank conflict comprises analyzing multiple instructions within a multi-instruction block.
